(19) United States
(12) Patent Application Publication
(10) Pub. No.: US 2026/0189825 A1
(43) Pub. Date: Jul. 2, 2026

(54) EXTENDABLE WIRELESS EARBUD CASE WITH MOUSE FUNCTIONALITIES

(71) Applicant: Nathan Jared Spackman, Kaysville, UT (US)

(72) Inventor: Nathan Jared Spackman, Kaysville, UT (US)

(21) Appl. No.: 19/546,268

(22) Filed: Feb. 20, 2026

Related U.S. Application Data
(63) Continuation-in-part of application No. 18/954,413, filed on Nov. 20, 2024, now Pat. No. 12,572,225.

(51) Int. Cl. H04R 1/02; H04R 1/10

(52) U.S. Cl. CPC H04R 1/02; H04R 1/1016; H04R 1/1041; H04R 2420/09

(57) ABSTRACT

An earbud case including a body having a curved top surface with ergonomics of a computer mouse and a flat bottom. The body can include an extendable portion that extends from a retracted position to an extended position. An effective length of the earbud case may be greater in the extended position than in the retracted position. The body may also include a section to receive a pair of earbuds. The section may charge the pair of earbuds when they are placed in the section. The curved top surface may include a compliant area, where compression of the compliant area causes a click signal to be generated. The click signal may correspond to a mouse command.

### CROSS-REFERENCE TO RELATED APPLICATIONS

This application is a continuation-in-part of U.S. patent application Ser. No. 18/954,413, filed Nov. 20, 2024, the entire contents of which are incorporated herein by reference.

### TECHNICAL FIELD

The instant specification generally relates to wireless peripheral devices. More specifically, the instant specification relates to an earbud case that has computer mouse functionalities.

### BACKGROUND

Wireless peripheral devices (e.g., wireless earbuds, wireless computer mice, wireless speakers, etc.) have become increasingly popular due to their convenience and portability. The increased portability provided by wireless peripheral devices has encouraged users to transport their wireless peripheral devices between their different workspaces, e.g., home offices, work offices, school, etc. Transporting peripherals between workspaces can leave users vulnerable to mistakenly leaving their devices in one workspace or the other. Wireless peripheral devices can be easily forgotten due to the number of peripheral devices a user needs to keep track of and due to the size of the peripheral devices being small, as in the case of wireless earbuds.

Others have tried to address these issues by adding compartments to one wireless peripheral device that allows for the storage of additional wireless peripheral devices, allowing a user to keep track of fewer devices. For example, others have developed computer mouse peripherals with earbud chambers at the bottom of the mouse that allow a user to store their earbuds and charge them. Other attempts include computer mouse peripherals with a compartment on the side that can house retractable or wireless earbuds. While these examples help users by reducing the number of devices they need to keep track of, these examples still pose additional disadvantages such as creating difficulty for the user to retrieve their earbuds by storing the earbuds on the bottom of the mouse or storing them on the side of the device.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a perspective side view of an example embodiment of an earbud case by which selected aspects of the present disclosure may be implemented, in accordance with various embodiments.

FIG. 2 is a perspective view of the example embodiment of the earbud case of FIG. 1 with the compliant lid removed, in accordance with various embodiments.

FIG. 3A is a perspective view of an example embodiment of a compliant lid for use with an earbud, in accordance with various embodiments.

FIG. 3B is a perspective side view of the example embodiment of the compliant lid of FIG. 3A, in accordance with various embodiments.

FIG. 4A is a perspective top view of the example embodiment of the earbud case of FIG. 1 with the compliant lid removed, in accordance with various embodiments.

FIG. 4B is a perspective top view of the example embodiment of the compliant lid of FIG. 3A, in accordance with various embodiments.

FIG. 5 is a schematic block diagram illustrating an example embodiment of a circuit for use in an earbud case by which selected aspects of the present disclosure may be implemented, in accordance with various embodiments.

FIG. 6 is a schematic block diagram illustrating an example embodiment of a printed circuit board (PCB) layout by which selected aspects of the present disclosure may be implemented, in accordance with various embodiments.

FIG. 7 is a perspective top view of an example embodiment of an earbud case assembly by which the example embodiment PCB of FIG. 6 is shown in relation to the example embodiment of the earbud case of FIG. 4A, in accordance with various embodiments.

FIG. 8 is a perspective view of an example embodiment of an earbud case in accordance with various embodiments.

FIG. 9 is a perspective view of an example embodiment of an earbud case in accordance with various embodiments.

FIG. 10A is a perspective side view of an earbud case in a retracted position with a slidable member in a closed position, in accordance with various embodiments.

FIG. 10B is a perspective view of the earbud case of FIG. 10A in a retracted position with the slidable member in a closed position, in accordance with various embodiments.

FIG. 11A is a perspective side view of the earbud case of FIG. 10A in an extended position with the slidable member in an open position, in accordance with various embodiments.

FIG. 11B is a perspective side view of the earbud case of FIG. 10A in an extended position with the slidable member in an open position, in accordance with various embodiments.

FIG. 12A is a perspective top view of the earbud case of FIG. 10A in a retracted position with the slidable member in an open position, in accordance with various embodiments.

FIG. 12B is a front view of the earbud case of FIG. 10A with the slidable member in a retracted position, in accordance with various embodiments.

FIG. 13 is a perspective view of an earbud case in an extended position, in accordance with various embodiments.

FIG. 14A is a top view of the earbud case of FIG. 13 in a retracted position, in accordance with various embodiments.

FIG. 14B is a top view of the earbud case of FIG. 13 in an extended position, in accordance with various embodiments.

FIG. 15A is a top view of an earbud case in a retracted position, in accordance with various embodiments.

FIG. 15B is a top view of the earbud case of FIG. 15A in a retracted position with a lid in an open position, in accordance with various embodiments.

FIG. 15C is a top view of the earbud case of FIG. 15A in an extended position, in accordance with various embodiments.

FIG. 15D is a side view of the earbud case of FIG. 15A in a retracted position, in accordance with various embodiments.

FIG. 16A is a top view of an earbud case in a retracted position, in accordance with various embodiments.

FIG. 16B is a top view of the earbud case of FIG. 16A in an extended position, in accordance with various embodiments.

FIG. 16C is a top view of the earbud case of FIG. 16A in an extended position with a lid in an open position, in accordance with various embodiments.

FIG. 17 is a schematic block diagram illustrating an example embodiment of a circuit board for use in an earbud case, in accordance with various embodiments.

### DETAILED DESCRIPTION

Existing peripheral devices that include compartments for storing other peripheral devices pose accessibility challenges to the user. For example, when a compartment for storing earbuds is located on the bottom or located on the side of a computer mouse peripheral, the user is required to lift and rotate the mouse in one hand and retrieve the stored earbuds with the other hand. This can cause stress for users when they need to quickly access their earbuds and continue using the computer mouse (i.e., to accept a call or join a video conference). Moving the earbud storage compartment to more accessible locations on the previous solutions, such as the top of the computer mouse, has been avoided as placing the compartments on top of the computer mouse interferes with the user's grip on the device while using the computer mouse functionalities.

Additionally, the space taken up by adding storage compartments limits the space available for common computer mouse components such as scroll wheels. Other solutions have reduced the size of computer mouse electronics by substituting scroll wheels with “smart” substrates that incorporate capacitive touch sensors into the top surface of the mouse and eliminate the need for scroll wheels. However, these “smart” substrates are expensive to manufacture and can be damaged or scratched while being transported inside a user's pocket, backpack, or bag with other loose items.

Furthermore, compact cases, such as earbud cases, while designed for portability and convenient storage, can present ergonomic challenges when used as computer mice. The compact form that makes these cases pocket-friendly creates an awkward size for a human hand to grip and manipulate as a mouse or pointing device. Users may experience discomfort or reduced precision when attempting to use a small earbud case as a computer mouse for extended periods due to the limited surface area available for gripping and the unnatural hand positioning required. And while conventional computer mice are designed for extended use and comfortable hand positioning, they are typically too large to be conveniently carried in a pocket or small bag. These size constraints can force users to choose between portability and ergonomic comfort.

Aspects and implementations of the present disclosure address the above deficiencies, among others, by providing an earbud case that integrates the functionalities of a computer mouse while storing earbuds on the top surface of the earbud case without affecting the user's grip on the earbud case. Additionally, the earbud case eliminates the need to replace a scroll wheel with an expensive substrate by implementing capacitive touch sensing while using cheap, durable materials for the surface of the mouse that contain no active electronics.

Furthermore, the present disclosure provides an earbud case with extendable configurations that can address the limitations of combining peripheral devices (such as a mouse and an earbud case) into a single compact peripheral device. When the provided earbud case is in a retracted state, the device maintains compact dimensions suitable for pocket storage and transport. When extended, the extendable portion increases the surface (or gripping) area available for a user when holding the device by increasing an effective length of the earbud case. This extendable design offers users both the portability of a compact earbud case and the comfort and grip of a larger mouse when the device is in use.

An earbud case is disclosed. The earbud case may include a body having a curved top surface and a flat bottom. The curved top surface may include a portion configured to receive a pair of earbuds. The portion may charge the pair of earbuds when the earbuds are placed in the first portion. The earbud case may also include a lid having a curved surface having the ergonomics of a computer mouse. The lid may slide along a slot formed on the body of the earbud case in a first direction to an open position exposing the curved top surface. The lid may also slide along the slot in a second direction to a closed position covering the curved top surface.

An earbud system is also disclosed. The earbud system may include an earbud case, a first earbud, and a second earbud. The earbud case may include a battery. The earbud case may include a circuit board having a power management sub-system coupled to the battery, a processing device; and a wireless communications component. The earbud case may also include a body with a curved top surface and a flat bottom. The curved top surface may include a portion configured to receive the first earbud and the second earbud. The first earbud and second earbud may be charged by the power management sub-system when placed in the portion. The earbud case may also include a lid having a curved surface having ergonomics of a computer mouse. The lid may slide along a slot formed on the body of the earbud case in a first direction to an open position to expose the curved top surface. The lid may slide along the slot in a second direction to a closed position to cover the curved top surface.

Another embodiment of an earbud case is also disclosed. The earbud case may include a battery, a circuit board that includes a power management sub-system coupled to the battery, and a processing device. The earbud case may also contain a wireless communications component. The earbud case may include a compliant lid having a curved surface having ergonomics of a computer mouse. The earbud case may further include a body having a curved top and a flat bottom, where the body is divided into a first portion and a second portion located on the curved top. The first portion may include a first and a second chamber having electrical contacts coupled to the power management sub-system to charge a first or second earbud when placed in the first or second chamber. The second portion may extend beneath the first portion. The second portion may include a first and second mouse button where the first or second mouse button may be activated by compression of the compliant lid and a corresponding compliant area of the curved top in a first or second area of the compliant lid above the first or second mouse buttons. The second portion may also include a touch panel, the touch panel being activated by the presence of a conductive object in a third area of the compliant lid and a corresponding third area of the curved top above the touch panel.

Another embodiment of an earbud case is also disclosed. The earbud case may include a body having a curved top surface with ergonomics of a computer mouse and a flat bottom. The body can include an extendable portion that extends from a retracted position to an extended position. An effective length of the earbud case may be greater in the extended position than in the retracted position. The body may also include a section to receive a pair of earbuds. The section may charge the pair of earbuds when they are placed in the section. The curved top surface may include a compliant area, where compression of the compliant area causes a click signal to be generated. The click signal may correspond to a mouse command.

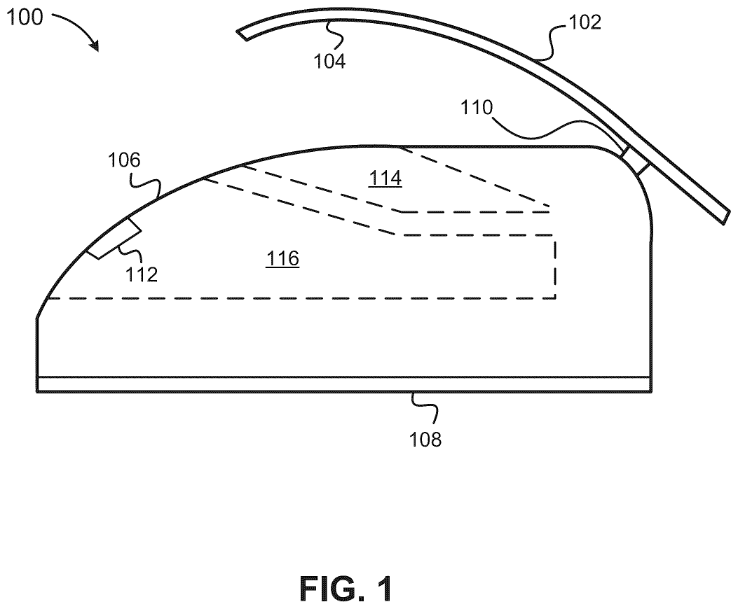

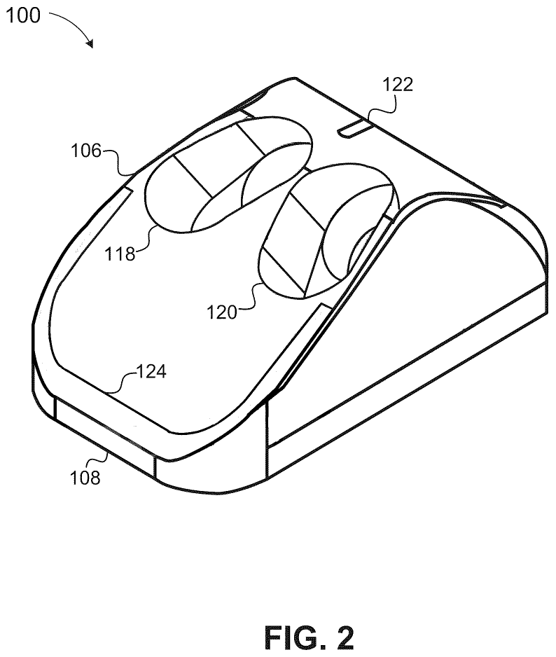

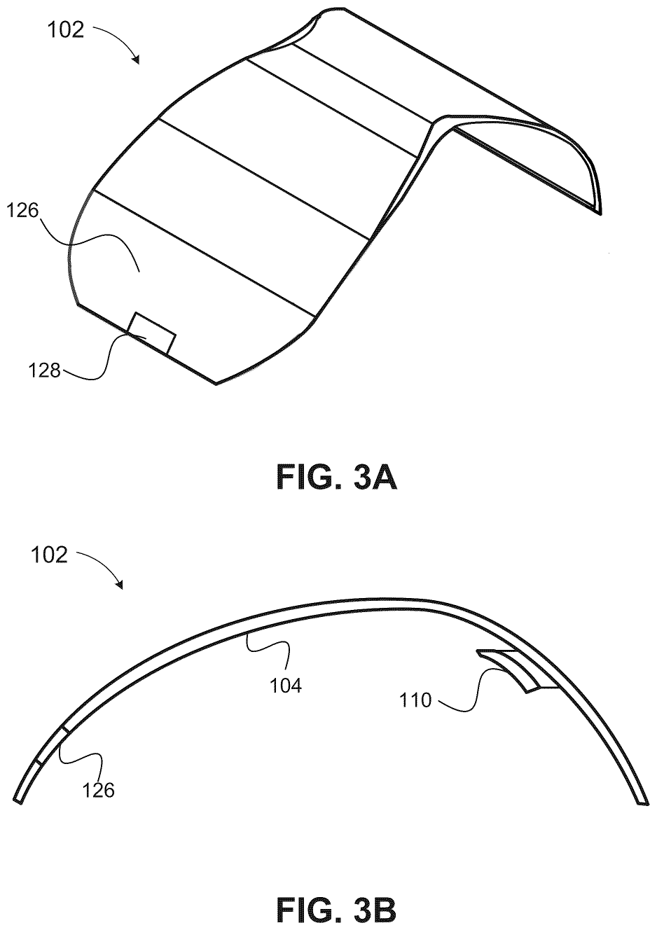

FIG. 1 depicts an example embodiment of an earbud case 100 with a compliant lid 102 in a semi-open position. The compliant lid 102 may include a curved surface 104 having the ergonomics of a computer mouse. The earbud case 100 may include a body having a curved top 106 and a flat bottom 108. The compliant lid 102 may selectively couple to the body of the earbud case 100 by a guide 110 inserted into a slot 122 formed on the curved top 106 as depicted in FIG. 2. The compliant lid 102 may slide along the slot 122 and rotate away from the curved top 106 to allow access to the curved top 106. The compliant lid 102 may also include an embedded lid magnet 126 depicted in FIG. 3A that magnetically couples to an embedded body magnet 112 in the curved top 106 to hold the compliant lid 102 in a closed position while the earbud case is transported or while the earbud case is used as a mouse. The compliant lid 102 may snap to the curved top 106 or may selectively couple to the curved top 106 in some other way.

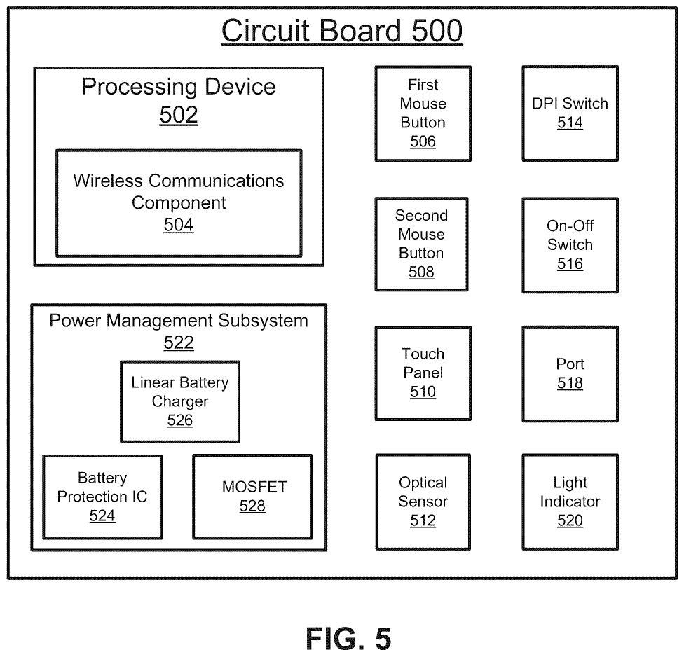

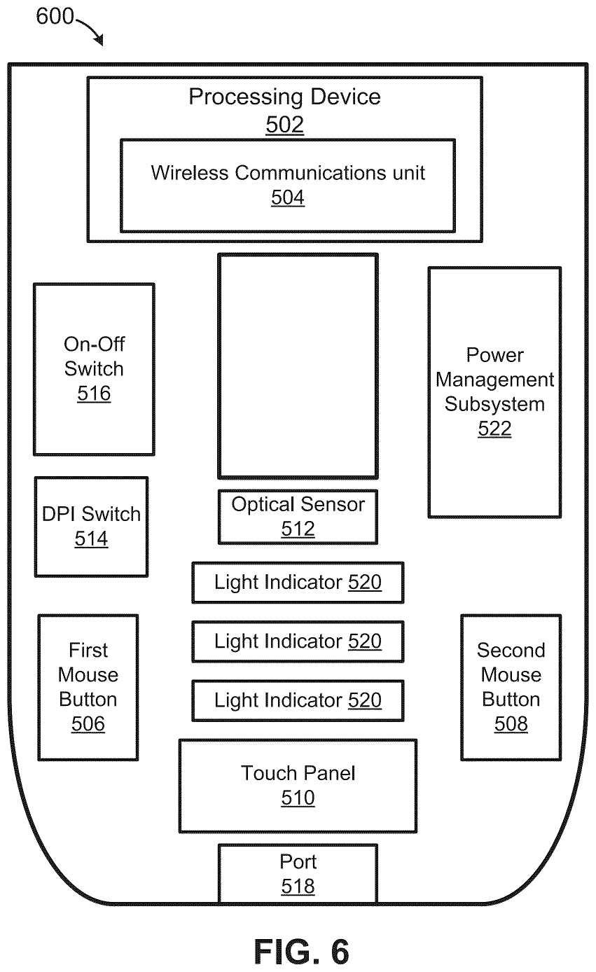

In some implementations, the body of the earbud case 100 may include a first portion 114 located on the curved top 106. The first portion 114 may be positioned at an angle from the curved top 106 to simplify access to the first portion 114 when the compliant lid 102 is in an open position. The body of the earbud case 100 may also include a second portion 116 located on the curved top 106 that also extends beneath the first portion 114. The second portion 116 may enclose a battery (not depicted). The battery can be a rechargeable battery. The battery may be a Lithium-Ion (Li-ion) battery. The battery may be a disposable battery. The second portion 116 may enclose a circuit board such as the circuit board 500 shown in FIG. 5. The second portion 116 may enclose a printed circuit board (PCB) such as the PCB 600 shown in FIG. 6. The second portion may also enclose a touch panel such as the touch panel 510 depicted in FIG. 5. The body of the earbud case 100 may contain all the active electronic components for the earbud case 100, e.g., the touch panel 510, the processing device 502, and the wireless communications component 504, or other components on circuit board 500 or PCB 600. The second portion may contain all the active electronic components for the earbud case 100.

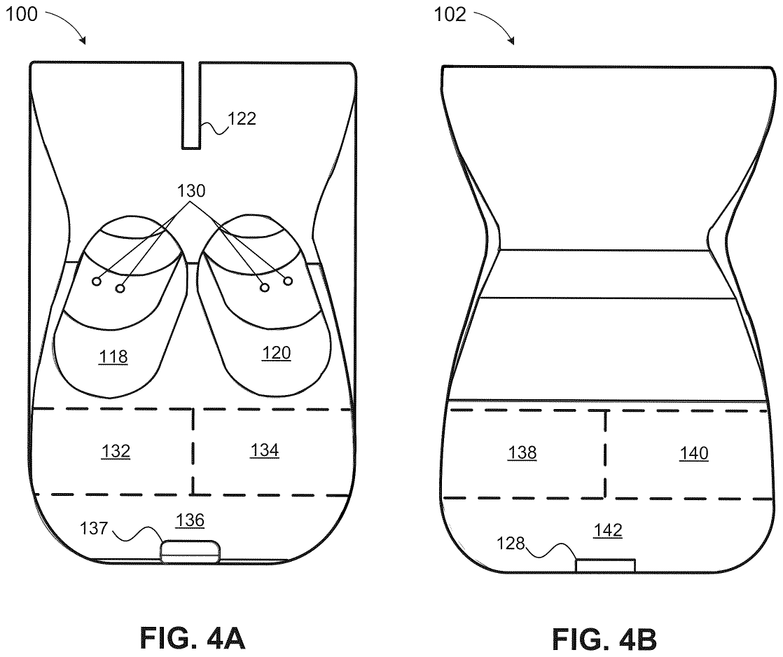

FIG. 2 depicts an example embodiment of the earbud case 100 of FIG. 1 with the compliant lid 102 removed. In some implementations, the first portion 114 may contain a first chamber 118 and a second chamber 120. The first chamber 118 may have electrical contacts, such as the electrical contacts 130 depicted in FIG. 4A, coupled to a power management subsystem, such as the power management subsystem 522 shown in FIG. 5, to charge a first earbud (not depicted) when placed in the first chamber 118. The first chamber 118 may extend into the curved top 106 to prevent the first earbud from protruding out the top of the first chamber 118, allowing the compliant lid 102 to rest flush against the curved top 106 when the compliant lid 102 is in a closed position. The second chamber 120 may also have electrical contacts, such as the electrical contacts 130 depicted in FIG. 4A, coupled to a power management subsystem, such as the power management subsystem 522 shown in FIG. 5, to charge a second earbud (not depicted) when placed in the second chamber 120. The second chamber 120 may extend into the curved top 106 to prevent the second earbud from protruding out the top of the second chamber 120, allowing the compliant lid 102 to rest flush against the curved top 106 when the compliant lid 102 is in a closed position. The first chamber 118 and the second chamber 120 may include magnets (not depicted) to hold the first and second earbuds in place for charging.

In some implementations, the curved top 106 may be formed to include a slot 122 that houses the guide 110 to provide a track for the guide 110 to slide along and allow the compliant lid 102 to slide open or to slide closed. The curved top 106 may couple to the flat bottom 108 leaving no gaps to prevent contaminants from entering the second portion 116. The curved top 106 may be comprised of a compliant material with a first compliance that allows the curved top 106 to travel when compressed. The curved top 106 may couple to the flat bottom 108 by a compliant region 124. The compliant region 124 may be made of a compliant material with a second compliance that is greater than the first compliance of the material of the curved top 106 to allow for travel when the curved top 106 is compressed. The curved top 106 may be made of a material having a first thickness and the compliant region 124 may be made of the same material as the curved top 106 having a second thickness, where the second thickness is less than the first thickness. The compliant region 124 may be made of a non-rigid adhesive such as glue, epoxy, or a similar adhesive. The curved top 106 may optionally leave a gap in place of the compliant region 124 between the curved top 106 and the flat bottom 108 to leave additional room for the curved top 106 to travel when compressed.

FIG. 3A depicts an example embodiment of the compliant lid 102 of the earbud case 100 of FIG. 1. The compliant lid 102 may include an embedded lid magnet 126. The embedded lid magnet 126 may overlap with an embedded body magnet 112 when the compliant lid 102 is in a closed position. The embedded lid magnet 126 and the embedded body magnet 112 may each have an associated polarity. The embedded lid magnet 126 may have an associated polarity that is opposite from the embedded body magnet 112 allowing the embedded lid magnet 126 to be attracted to the embedded body magnet 112 and maintain the lid in a closed position while the earbud case is transported. One of the embedded body magnet 112 or the embedded lid magnet 126 may be substituted with an embedded piece of metal that is attracted to magnetic forces. The compliant lid 102 may rest flush with the curved top 106 and prevent the first and second earbuds from falling out of the first chamber 118 and the second chamber 120 when the earbud case 100 is transported or used as a mouse.

The compliant lid 102 may also form a charging port slot 128 that allows a charging cord to be plugged into the earbud case 100 through the compliant lid 102. The compliant lid 102 may be configured to contain no active electronics.

FIG. 3B depicts an example embodiment of the compliant lid 102 of the earbud case 100 of FIG. 1. The view of FIG. 3B depicts components not seen in FIG. 3A. The compliant lid 102 may include a guide 110 that removably inserts into the slot 122. The guide 110 may slide along the slot 122 to move the compliant lid to an open or closed position. The guide 110 may be a slide joint. The guide 110 may include wheels or bearings to facilitate sliding motions. The guide 110 may permanently insert into the slot 122.

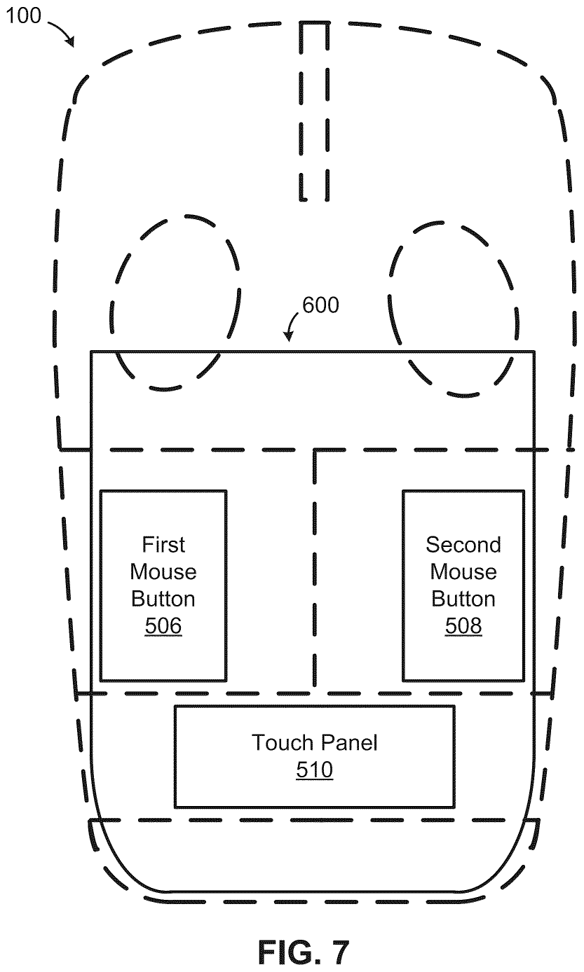

FIG. 4A depicts an example embodiment of the earbud case 100 of FIG. 1 with the compliant lid removed. In some implementations, the curved top 106 may include a first compliant area 132 located above the first mouse button 506 as depicted in FIG. 7. The first compliant area 132 may correspond to the first area 138 of the compliant lid 102. The first compliant area 132 may include visual indicators outlining the first compliant area 132 shown with the dashed lines in FIG. 4A. The first compliant area 132 may have no visual indicators outlining the first compliant area 132. When the curved top 106 is compressed in the first compliant area 132, the first mouse button 506 may be activated. The curved top 106 may also include a second compliant area 134 located above the second mouse button 508 as depicted in FIG. 7. The second compliant area 134 may correspond to the second area 140 of the compliant lid. The second compliant area 134 may have visual indicators outlining the second compliant area 134 shown with the dashed lines in FIG. 4A. The second compliant area 134 may have no visual indicators outlining the second compliant area 134. When the curved top 106 is compressed in the second compliant area 134, the second mouse button 508 may be activated.

The curved top 106 may include a third area 136 located above the touch panel 510 as depicted in FIG. 7. The touch panel 510 may be activated by detecting the presence of a conductive object, such as a finger or a stylus, in the third area 136. The third area 136 may have visual indicators outlining the third area 136 shown with the dashed lines in FIG. 4A. The third area 136 may overlap with the first compliant area 132 and the second compliant area 134. The third area 136 may occupy the area in between the first compliant area 132 and the second compliant area 134. The third area 136 may extend to the compliant region 124 where the curved top 106 couples to the flat bottom 108.

The curved top 106 may also be formed to include a charging slot 137 allowing for a charging cord to be inserted into the port 518 depicted in FIG. 5 through the curved top 106. The charging slot 137 may accommodate a Universal Serial Bus (USB) Type-C (USB-C) charging cord or a similar cord. The charging slot 137 may align with the charging port slot 128 allowing the charging cord to be inserted through both the compliant lid 102 and the curved top 106.

FIG. 4B depicts an example embodiment of the compliant lid 102 of FIG. 2. In some implementations, the compliant lid 102 may include a first area 138. The first area 138 may have visual indicators outlining the first area 138 as shown with the dashed lines in FIG. 4B. The first area 138 may have no visual indicators outlining the first area 138. The first area 138 may overlap with the first compliant area 132 of the curved top 106 shown in FIG. 4A when the compliant lid is in a closed position. The first area 138 may cover a larger area than the first compliant area 132 of the curved top 106. The first area 138 may cover a smaller area than the first compliant area 132 of the curved top 106. The first area 138 may cover the same area as the first compliant area 132 of the curved top 106. The first area 138 of the compliant lid 102 and the first compliant area 132 of the curved top 106 may be positioned over the first mouse button 506 when the compliant lid 102 is in a closed position. When the compliant lid 102 is in a closed position, the first mouse button 506 may be activated by compressing the compliant lid 102 in the first area 138 which in turn compresses the curved top 106 in the first compliant area 132. When the compliant lid 102 is in an open position, the first mouse button 506 may be activated by compressing the curved top 106 in the first compliant area 132.

The compliant lid 102 may include a second area 140. The second area 140 may have visual indicators outlining the second area 140 as shown with the dashed lines in FIG. 4B. The second area 140 may have no visual indicators outlining the second area 140. The second area 140 may overlap with the second compliant area 134 of the curved top 106 shown in FIG. 4A when the compliant lid is in a closed position. The second area 140 may cover a larger area than the second compliant area 134 of the curved top 106. The second area 140 may cover a smaller area than the second compliant area 134 of the curved top 106. The second area 140 may cover the same area as the second compliant area 134 of the curved top 106. The second area 140 of the compliant lid 102 and the second compliant area 134 of the curved top 106 may be positioned over the second mouse button 508 when the compliant lid 102 is in a closed position. When the compliant lid 102 is in a closed position, the second mouse button 508 may be activated by compressing the compliant lid 102 in the second area 140 which in turn compresses the curved top 106 in the second compliant area 134. When the compliant lid 102 is in an open position, the second mouse button 508 may be activated by compressing the curved top 106 in the second compliant area 134.

The compliant lid 102 may include a touch panel area 142. The touch panel area 142 may have visual indicators outlining the touch panel area 142 as shown in FIG. 4B. The touch panel area 142 may have no visual indicators outlining the touch panel area 142. The touch panel area 142 may overlap with the first area 138 and the second area 140. The touch panel area 142 may be positioned between the first area 138 and the second area 140. The touch panel area 142 may cover the same area as the third area 136 when the compliant lid is in a closed position. The touch panel area 142 may cover a smaller area than the third area 136. The touch panel area 142 may cover a larger area than the third area 136. The touch panel area 142 and the third area 136 may be positioned over the touch panel 510 when the compliant lid 102 is in a closed position. When the compliant lid 102 is in a closed position, the touch panel 510 may be activated by the presence of a conductive object, such as a finger or a stylus, detected by the touch panel 510 in the touch panel area 142 and the third area 136 of the curved top 106. When the compliant lid 102 is in an open position, the touch panel 510 may be activated by detecting the presence of a conductive object in the third area 136 of the curved top 106.

FIG. 5 depicts an example block schematic of a circuit board 500. The circuit board 500 may be housed in the second portion 116 of the earbud case 100. The circuit board 500 may include a processing device 502. The processing device 502 may be a processor such as a microcontroller, a system on a chip (SOC) or the like. The processing device 502 may include a wireless communications component 504 built into the processing device 502. The wireless communications component 504 may be an onboard printed circuit board (PCB) antenna. The wireless communications component 504 may be a separate component from the processing device 502 and be electrically coupled to the processing device 502.

The processing device 502 may be programmed to support communication protocols such as Bluetooth, Bluetooth Low Energy (BLE), or Wi-Fi and communicate wireless communications through the wireless communications component 504. The processing device 502 may be programmed to communicatively couple or “pair” the earbud case 100 to a host device (not depicted) such as a laptop, a desktop computer, a smartphone, etc., using the wireless communications component 504. The processing device 502 may be programmed to transmit wireless communications from the earbud case 100 to a host device by the wireless communications component 504 and receive wireless communications sent from the host device to be received by the earbud case 100 through the wireless communications component 504.

The processing device 502 may be programmed to use the wireless communications component 504 to transmit mouse functions performed with the earbud case 100 to a host device, where they are executed by a cursor on the host device's screen. Mouse functions that may be communicated to the host device may include scroll commands, left click commands, right click commands, or slide commands. Scroll commands may include a command to scroll contents of a window on the screen of the host device up and down or left and right corresponding to the movement of a conductive object activating the touch panel 510. Left click commands may include selecting an object, such as a graphic or link, on the screen of the host device with a cursor in response to the first mouse button 506 being activated. Right click commands may include opening an options menu on the screen of the host device with a cursor in response to the second mouse button 508 being activated. Slide commands may include moving a cursor on the screen of the host device in a direction of movement corresponding to a direction of movement of the earbud case 100. The processing device 502 may receive wireless communications by the wireless communications component 504 from the host device communicating earbud case functions to be performed by the earbud case 100 and the first and second earbuds (not depicted) to the earbud case 100. The earbud case functions to be performed by the earbud case 100 and the first and second earbuds may include functions such as receiving audio data for the first or second earbuds to transmit through speakers in the earbuds, accepting a call, or hanging up a call. The processing device 502 may be programmed to permit mouse functions and earbud case functions to be performed simultaneously.

The processing device 502 may also be programmed to enter a low-power mode if the mouse functionalities of the earbud case 100 have not been utilized within a predetermined period of time (e.g., 30 seconds). The processing device 502 may be programmed to enter the low-power mode if the first mouse button 506, the second mouse button 508, or the touch panel 510 have not been activated for the predetermined period of time. The processing device 502 may be programmed to enter the low-power mode if the earbud case 100 has not been moved for the predetermined period of time. The low-power mode may be a battery saving mode where the processing device 502 is programmed to turn mouse functionalities off, i.e., slide commands not being sent in response to the earbud case 100 being moved or the like. The processing device 502 may be programmed to exit the low-power mode if an activation action is taken. The activation action may be activating the first or second mouse buttons or the like.

The circuit board 500 may include a first mouse button 506 and a second mouse button 508. The first mouse button 506 and the second mouse button 508 may be an actuator such as snap action switches, push buttons, or the like. The first mouse button 506 and the second mouse button 508 may both be the same kind of actuator, i.e., both snap action switches, or may be different types of actuators, i.e., the first mouse button 506 is a snap action switch and the second mouse button 508 is a push button. The first mouse button 506 may be positioned on the left side of the earbud case 100 as depicted in FIG. 7, and, when activated, may transmit a signal to the processing device 502 that corresponds to a left click command. The second mouse button 508 may be positioned on the right side of the earbud case 100 as depicted in FIG. 7, and, when activated, may transmit a signal to the processing device 502 that corresponds to a right click command.

The circuit board 500 may include a touch panel 510. The touch panel 510 may include multiple electrodes electrically coupled together. The multiple electrodes may be capacitors. The touch panel 510 may include a single capacitive touch sensor. The touch panel 510 may include multiple capacitive touch sensors. The touch panel 510 may track the motion of a conductive object moving along one directional axis, such as up and down or along a y-axis. The touch panel 510 may track the motion of a conductive object moving along more than one directional axis, such as up and down and left and right or along a y-axis and an x-axis. The touch panel, when activated, may transmit a signal to the processing device 502 that corresponds to a scroll command.

The circuit board 500 may include an optical sensor 512. The optical sensor 512 may track a direction of movement of the earbud case 100 and translate the movement into instructions to transmit to the processing device 502 that corresponds to a slide command to move the cursor in the direction of movement of the earbud case 100 on the screen of a host device. The sensitivity of the optical sensor 512 may be adjusted by selections made with a dots per inch (DPI) switch, such as the DPI switch 514. The DPI switch 514 may be a slide switch, a push button, or a similar actuator. The DPI switch 514 may allow a user to adjust the sensitivity level of the optical sensor 512 to a higher sensitivity level or a lower sensitivity level. A higher sensitivity level requires the earbud case 100 to be moved a shorter distance in order for the optical sensor 512 to transmit a signal to the processing device 502 to send a slide command to the host device. A lower sensitivity level requires the earbud case 100 to be moved a longer distance in order for the optical sensor 512 to transmit a signal to the processing device 502 to send a slide command to the host device.

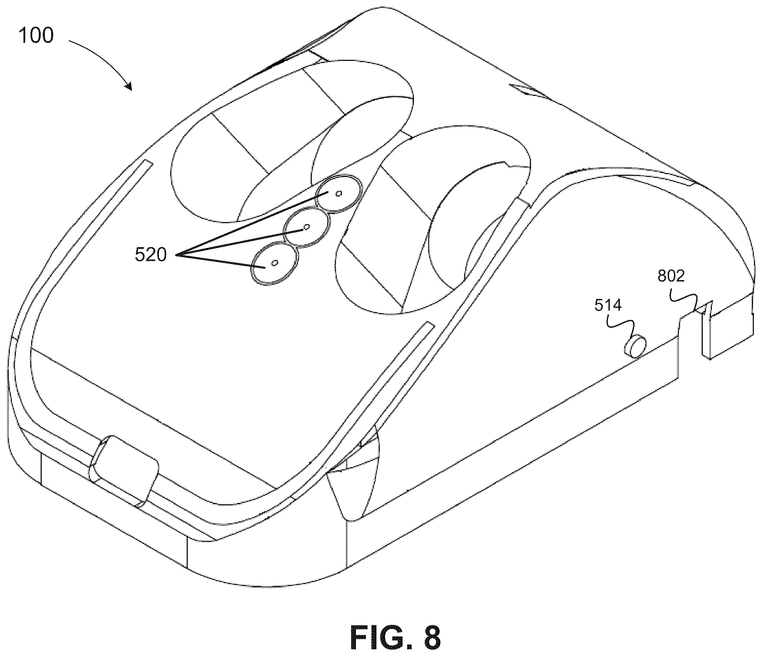

The circuit board 500 may include an on-off switch 516 configured to switch the earbud case 100 on or off. The on-off switch 516 may be a slide switch. The on-off switch 516 may be a push button or the like. The on-off switch 516 may turn off mouse functionalities when switched to off and allow the first and second earbuds to continue charging. The on-off switch 516 may turn off both the earbud case functionalities and the mouse functionalities. The on-off switch 516 may be located on the side of the earbud case and protrude through an on-off slot 802 formed on the side of the earbud case 100 as shown in FIG. 8.

In some implementations, the circuit board 500 may include a port 518. The port 518 may include a power charging port, a data connection port, or some other type of port. The port 518 may provide an interface between the earbud case 100 and some other device or a power source. The port 518 may be connectable to a cable. The cable may supply power to the earbud case 100 to charge the battery. The cable may transmit data to the earbud case 100 and transmit data from the earbud case 100. In one implementation, the port 518 may include a Universal Serial Bus (USB) port (e.g., a USB-C port, a USB Mini-B port, a USB Micro-B port, or some other type of USB port) or some other type of charging or data connection port. In some embodiments, the port 518 may include a port cover. The port 518 may be coupled to the power management subsystem 522 where the port is used to connect to a power source to charge the battery.

In some embodiments, the earbud case can be used as a host-interface bridge for audio communications. The processing device 502 can further include (or be coupled to) a wired host interface controller (e.g., a USB device controller) so the earbud case 100 can couple to a host device through port 518. When coupled to the host device through port 518, the processing device 502 may be programmed to enumerate as an audio peripheral device using a standardized host protocol (e.g., USB Audio Class). The processing device 502 may thereby receive digital audio streams from the host device over the wired interface and provide digital audio streams to the host device over the wired interface (e.g., microphone audio captured by one or more earbuds). In some embodiments, port 518 is configured to provide both power and data connectivity to a host device and supports audio communications between the host device and the earbud case 100. For example, when the earbud case 100 is coupled to a host device through port 518, the earbud case 100 may present itself to the host device as an external sound card, headset, or other audio endpoint using a standardized USB audio protocol. In such embodiments, enumerating as the standardized host protocol may comprise presenting an audio device interface to the host device that exposes one or more playback endpoints and/or microphone endpoints.

In some embodiments, port 518 and its associated circuitry (e.g., a USB device controller, connector, and/or related firmware) may be referred to as a host interface component configured to communicatively couple the earbud case 100 to a host device. In such embodiments, the host interface component may be configured to cause the earbud case 100 to present an audio device interface to the host device (e.g., a USB Audio Class interface or other standardized audio peripheral interface) such that the earbud case 100 bridges audio between the host device and one or more earbuds.

The processing device 502 may be further programmed to establish a wireless audio connection between the earbud case 100 and one or more earbuds and to bridge audio between the host device and the earbuds, such that the earbud case 100 bridges audio between the host device and the earbuds during operation. Bridging may include packetizing, buffering, decoding/encoding, resampling, and/or otherwise translating between a wired audio transport protocol used by the host device and a wireless audio transport protocol used by the earbuds. In some embodiments, control data (e.g., volume control, call accept/hang-up, mute, and/or playback controls) is also bridged between the host device and the earbuds.

In some embodiments, when the earbud case 100 is coupled to the host device through port 518, the processing device 502 is programmed to cause the earbud case 100 to automatically connect to a previously-associated set of earbuds based on stored association information (e.g., pairing keys stored in memory). In this manner, the host device may begin routing audio through the earbud case 100 without requiring the host device to perform Bluetooth pairing steps with the earbuds.

For example, the earbud case 100 may couple to a host device through a wired interface (e.g., a Universal Serial Bus (USB) interface) and present to the host device a standardized audio peripheral profile (e.g., USB Audio Class). In such embodiments, the host device may route audio to the earbud case through the wired interface without requiring Bluetooth pairing steps on the host device.

Earbud case 100 may establish and maintain a wireless audio connection with one or more earbuds and may bridge audio between the host device and the earbuds by translating between a wired host protocol and a wireless earbud protocol. In some embodiments, the earbud case also presents a human-interface-device (HID) profile to the host device (e.g., for mouse functions), thereby operating as a device that supports both mouse input and audio communications.

In some embodiments, when earbud case 100 is coupled to a host device through port 518, processing device 502 may be programmed to automatically enumerate as a HID for mouse input, such that mouse functionality is automatically available to the host device upon connection without requiring manual pairing or configuration steps. Earbud case 100 may simultaneously enumerate as both a USB Audio Class device and a USB HID device, presenting a composite device interface to the host device. In this manner, both mouse input and audio communications may be available to the host device immediately upon physical connection of the earbud case 100 to the host device through port 518.

In some embodiments, earbud case 100 may be configured to operate in multiple operating modes including a PC mode and a Bluetooth mode. In PC mode, earbud case 100 may couple to a host device through a wired interface (such as port 518) or through a wireless receiver (such as a USB dongle), and mouse input and audio may be routed through the wired or receiver-based connection. In Bluetooth mode, earbud case 100 and/or the earbuds may wirelessly connect to one or more devices using Bluetooth or BLE protocols. Earbud case 100 may include switching logic to transition between operating modes. The switching logic may be manual (e.g., activated by a user through a switch or button) or automatic (e.g., triggered by detection of a USB connection, removal of the USB connection, or other connection state changes). In some embodiments, the earbuds may maintain an independent Bluetooth connection to a mobile device while earbud case 100 is connected to a different host device in PC mode, allowing the user to receive audio from multiple sources.

In some implementations, the circuit board 500 may include one or more light indicators 520. The one or more light indicators 520 may include a light assembly configured to emit light to indicate information about the earbud case 100. The one or more light indicators 520 may include a light-emitting diode (LED) or some other lighting device. The one or more light indicators 520 may indicate whether the earbud case 100 is on, a battery level of the earbud case 100, whether the earbud case 100 is currently charging, whether the first or second earbuds are currently charging, or some other state or configuration of the earbud case 100. In one implementation, the one or more light indicators 520 may be disposed on the curved top 106. As an example, a first light indicator 520 may include a light that illuminates when the earbud case 100 is on and does not illuminate when the device is off. A second light indicator 520 may illuminate when the earbud case 100 is charging and may not illuminate when the device is not charging. A third light indicator 520 may illuminate when the first or second earbuds are charging and may not illuminate when the first or second earbuds are not charging.

The circuit board 500 may also include a power management subsystem 522. The power management subsystem 522 may be connected to the electrical contacts 130 and may be configured to charge the first and second earbuds when placed inside the first chamber 118 and second chamber 120. The power management subsystem 522 may also be configured to charge the battery when connected to a power source.

The power management subsystem 522 may include a battery protection integrated circuit (IC) 524. The battery protection IC 524 may be configured to provide overcharge and high-temperature protection to the battery during charging by discharging the battery or stopping the battery from charging. The power management subsystem 522 may also include a linear battery charger 526. The linear battery charger 526 may be configured to maintain a consistent output voltage to the battery during charging. The linear battery charger may be a linear Li-ion battery charger. The power management subsystem 522 may also include one or more metal-oxide-semiconductor field effect transistors (MOSFETs) 528. The one or more MOSFETs 528 may be configured to facilitate charging and discharging of the battery. MOSFET 528 may be a dual N-channel MOSFET.

The circuit board 500 may include memory (not depicted). The memory may include volatile memory or non-volatile memory. The memory may include read-only memory (ROM), flash memory, dynamic random-access memory (DRAM), such as synchronous DRAM (SDRAM), double data rate (DDR) SDRAM), static random-access memory (SRAM), or some other type of memory.

FIG. 6 depicts an example block schematic of a printed circuit board (PCB) 600 implementation of the circuit board 500 of FIG. 5. The port 518 may be placed along an outside edge of the PCB 600 to allow a cord or a USB or similar cable to be plugged into the port 518. The on-off switch 516 and the DPI switch 514 may also be placed along an outside edge of the PCB 600 to allow the physical components to extend past the edge and protrude through slots formed on the sides of the earbud case 100, such as the on-off slot 802 depicted in FIG. 8.

FIG. 7 depicts a perspective view of the PCB 600 with an overlay of the earbud case 100 with the compliant lid 102 removed depicted with the dashed lines. The PCB 600 may extend beneath the first chamber 118 and the second chamber 120. The first mouse button 506 may be disposed beneath first compliant area 132 such that when the curved top 106 is compressed in the first compliant area 132, the first mouse button 506 is activated. The second mouse button 508 may be disposed beneath the second compliant area 134, such that when the curved top 106 is compressed in the second compliant area 134, the second mouse button 508 is activated. The touch panel 510 may be disposed beneath the third area 136, such that when a conductive object contacts the third area 136, the touch panel 510 is activated.

FIG. 8 provides a perspective view of another embodiment of the earbud case 100 with the compliant lid 102 removed. The earbud case 800 may include light indicators 520 disposed on the curved top 106 surface to convey information about the earbud case 100, such as charging status, battery level, or more. An on-off slot 802 may be formed on the side of the earbud case 100 to accommodate an actuator protruding through the on-off slot 802, such as the on-off switch 516 or the DPI switch 514.

FIG. 9 provides a perspective view of another embodiment of the earbud case 100 with the compliant lid 102 removed. The earbud case 900 may include a first portion 114 with an open section 902 in place of the first chamber 118 and second chamber 120. The open section 902 may be configured to receive a pair of earbuds. The open section 902 may be configured to accommodate earbuds of different shapes than the first and second earbuds. The open section 902 may contain electrical contacts like electrical contacts 130. The open section 902 may charge an earbud when the earbud is inserted into the open section 902. The open section 902 may accommodate a first pair of earbuds or a second pair of earbuds that have earbuds of different shapes than the first pair of earbuds.

The open section 902 may be configured to accommodate sockets that are insertable to the open section 902. The sockets may contain electrical contacts that insert into the electrical contacts like electrical contacts 130 in the open section 902. The sockets may be configured to house a wireless earbud of a specific shape. The sockets may be configured to charge an earbud housed in the socket when the socket is inserted into the open section 902. The sockets may plug into the open section 902 to form a first and second earbud chamber. A first socket housing one shape of earbud may be inserted into one side of the open section 902 and a second socket housing another shape of earbud may be inserted into the other side of the open section 902. The first and second sockets may accommodate earbud shapes that are different from the shapes of the first and second earbuds.

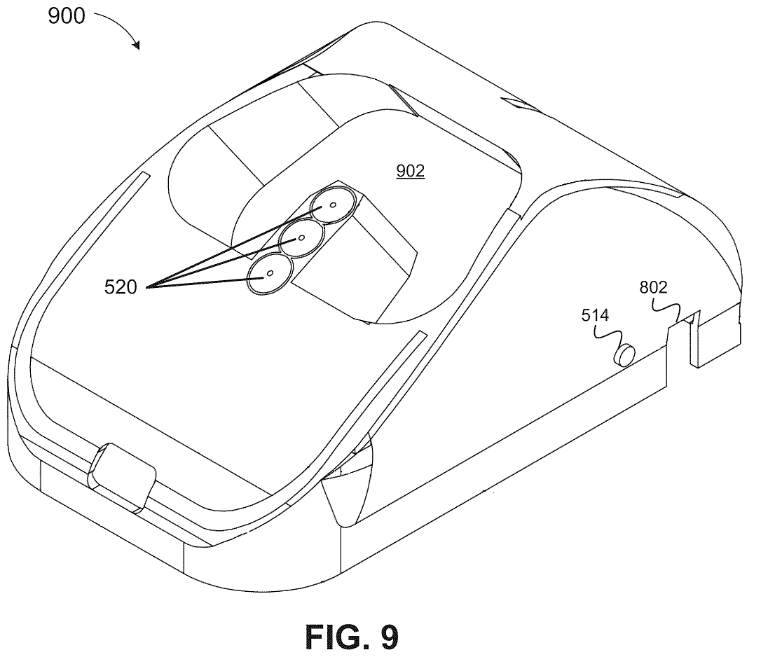

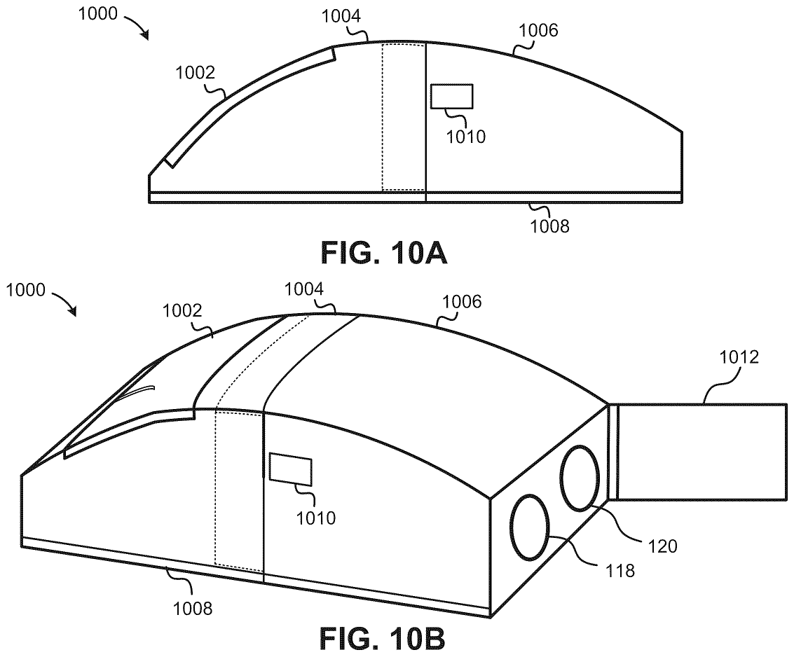

FIG. 10A depicts a perspective side view of an earbud case 1000 in a retracted position, with a slidable member 1002 in a closed position. The earbud case 1000 may include a body having a curved top surface and a flat bottom 1008. The curved top surface may have the ergonomics of a computer mouse. The curved top surface may be shaped and dimensioned to fit comfortably within a user's palm, to allow a user's fingers to rest naturally on the slidable member, and to permit the user to manipulate the earbud case as a computer mouse.

The body may include an extendable portion 1004 and a non-extendable portion 1006. The designations “extendable portion” and “non-extendable portion” should be understood as naming conventions used to distinguish between different portions of the body. In some implementations, the roles of these portions may be reversed such that the portion designated as the extendable portion 1004 acts as the non-extendable portion and the portion designated as the non-extendable portion 1006 acts as the extendable portion, without departing from the scope of the present disclosure. In some embodiments, extendable portion 1004 is an outer shell, a sleeve, or housing that extends (e.g., slides or translates) relative to an inner chassis, frame, or core (such as body portion 1014 and/or the portion designated as non-extendable portion 1006). In such embodiments, overlap between the shell and one or more portions of the body may be reduced when the extendable portion 1004 is in the extended position relative to the retracted position.

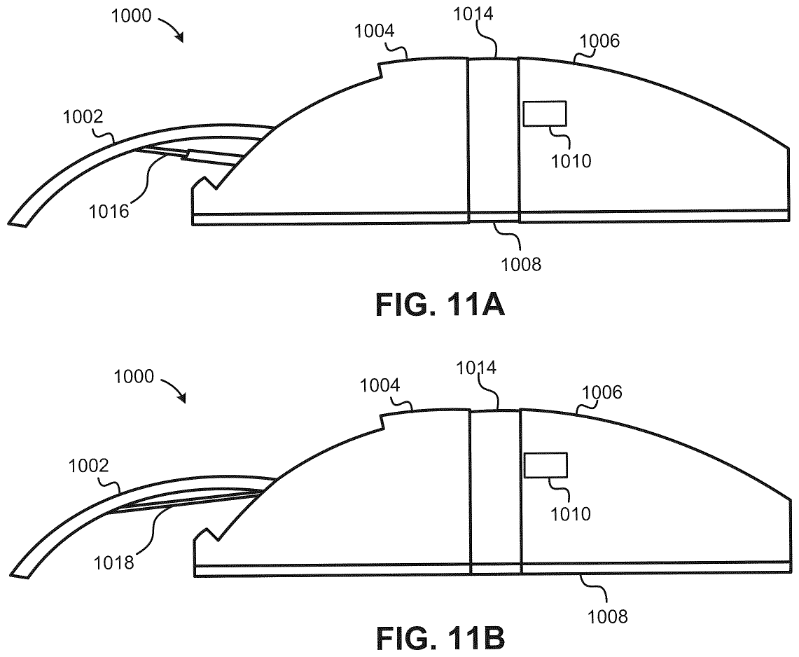

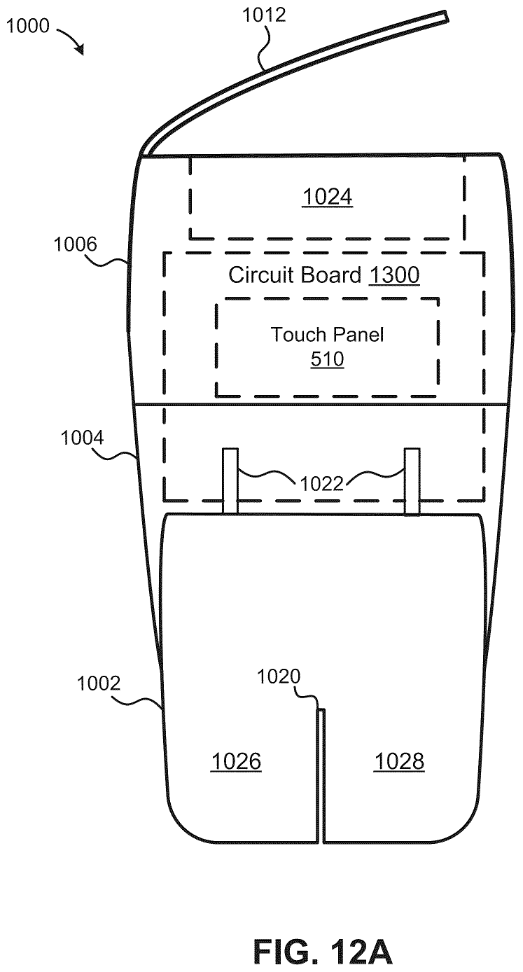

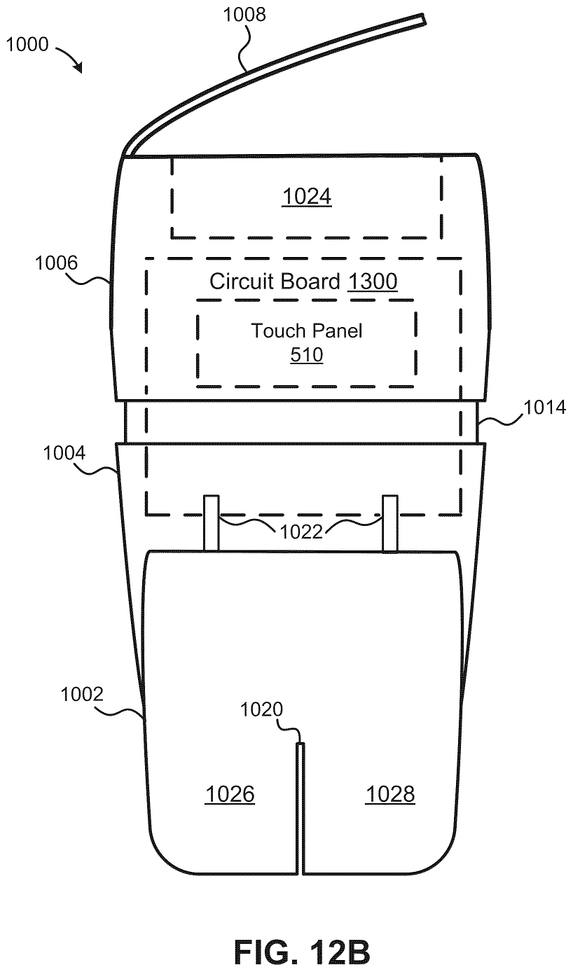

The extendable portion 1004 may be configured to extend relative to the non-extendable portion 1006 between the retracted position shown in FIG. 10A and an extended position, for example as depicted in FIGS. 11A, 11B, and 12B. The extendable portion 1004 may comprise, substantially, a half of the earbud case 1000, a quarter of the earbud case 1000, three quarters of the earbud case 1000, or a similar portion of the earbud case 1000. Extending extendable portion 1004 to the extended position may increase a distance between section 1024 of the body and slidable member 1002. Increasing this distance may improve ergonomics by providing increased grip length and/or surface area to the user's hand when the earbud case 1000 is in the extended position relative to the retracted position. An effective length of the earbud case 1000 may be greater in the extended position than in the retracted position. The effective length of the earbud case 1000 may be increased by extending the extendable portion 1004 from the retracted position to the extended position, by sliding the slidable member 1002 from the closed position to the open position, or by a combination of both.

In some implementations, extendable portion 1004 may include a shell that slides or telescopes over a stationary or semi-stationary portion of the body of earbud case 1000 (such as body portion 1014). The forward-sliding shell may translate along the body to increase the distance between the section and the slidable member while maintaining a substantially continuous exterior surface that conceals internal components of earbud case 1000, such as earbud or mouse components, electronics, circuit components and circuit boards, or other similar components. As the shell translates forward, overlap between the shell and one or more portions of the body may be reduced.

In some embodiments, extendable portion 1004 may comprise an outer shell that substantially surrounds the body of the earbud case. The outer shell may contain no active electronics. The outer shell may slide along the body in a rearward direction to transition the earbud case from the retracted position to the extended position. When the outer shell is in the retracted position, the outer shell may enclose and overlap with one or more internal portions of the body. When the outer shell slides to the extended position, the effective length of the earbud case may be increased. The outer shell may maintain a substantially continuous exterior surface in both the retracted and extended positions.

The non-extendable portion 1006 may include any portions of the body that are not included in the extendable portion 1004. In some implementations, non-extendable portion 1006 includes section 1024 and body portion 1014.

Slidable member 1002 may include a compliant section located on the curved top surface of the body. Slidable member 1002 may be slidably coupled to the curved top surface and may move, translate or slide between the closed position shown in FIG. 10A and an open position. When in the closed position, slidable member 1002 may lie substantially flush with the curved top surface to provide a smooth and continuous surface profile. Slidable member 1002 may also be curved to match the ergonomics of the curved top surface when the curved top surface has the ergonomics of a computer mouse, thereby maintaining an ergonomic shape when slidable member 1002 is in the closed position. In some implementations, slidable member 1002 includes more than one compliant area, such as a first compliant area 1026 and a second compliant area 1028. Slidable member 1002 may occupy different amounts of surface area of the curved top surface than is depicted in the figures. In some implementations, slidable member 1002 occupies an area that is substantially the same as a portion of the curved top surface that is part of the extendable portion 1004. In such implementations, a touch panel 510 may be disposed beneath slidable member 1002 and may be accessible when slidable member 1002 is in the open position. In some embodiments, slidable member 1002 occupies substantially all of the curved top surface except for a portion disposed above the touch panel 510. In other embodiments, slidable member 1002 occupies a smaller portion of the curved top surface such as substantially a half, a third, a fourth, or a similar amount of the curved top surface. An effective length of the earbud case 1000 may be greater in the extended position than in the retracted position. The effective length of the earbud case 1000 may be increased by extending the extendable portion 1004 from the retracted position to the extended position, by sliding the slidable member 1002 from the closed position to the open position, or by a combination of both.

Earbud case 1000 may include a detent mechanism to releasably retain the extendable portion 1004 in the retracted position. The detent mechanism may include a detent feature that engages a corresponding recess, shoulder, or catch to resist translation of the extendable portion 1004 when the extendable portion 1004 is in the retracted position. In some implementations, the detent mechanism includes a magnetic detent, a mechanical detent, or a combination thereof. Earbud case 1000 may further include a release mechanism 1010 (e.g., a button, lever, slider, or switch) to disengage the detent feature from the corresponding recess, shoulder, or catch, thereby permitting the extendable portion 1004 to move from the retracted position to the extended position. Release mechanism 1010 may be disposed on the extendable portion 1004 and may be actuated by a user to disengage the detent mechanism and permit the extendable portion 1004 to move from the retracted position to the extended position. In some embodiments, the release mechanism 1010 may be disposed on the non-extendable portion 1006.

FIG. 10B depicts a perspective view of earbud case 1000 in a retracted position with slidable member 1002 in a closed position.

Non-extendable portion 1006 may include a section 1024. Section 1024 may receive a pair of earbuds. In some embodiments, section 1024 includes a first chamber 118 and a second chamber 120. Similar to the first portion 114, which has been previously described, section 1024 may be configured to receive a pair of earbuds, wherein section 1024 is configured to charge the pair of earbuds when placed in section 1024. First chamber 118 and second chamber 120 may have electrical contacts coupled to a power management subsystem, such as power management subsystem 522 shown in FIG. 5, to charge a first earbud when placed in first chamber 118 and a second earbud when placed in second chamber 120. First chamber 118 and second chamber 120 may include magnets to hold the first and second earbuds in place for charging. In some embodiments, section 1024 may be positioned on the curved top surface of non-extendable portion 1006.

A lid 1012 may be coupled to the body and configured to cover first chamber 118 and second chamber 120. Lid 1012 may hold the earbuds in place when earbud case 1000 is transported or used as a mouse. Lid 1012 may be hinged to non-extendable portion 1006 or may be removably coupled to non-extendable portion 1006.

Flat bottom 1008 may extend along the base of earbud case 1000. Flat bottom 1008 may provide a stable surface that allows earbud case 1000 to rest on flat surfaces such as a desk, table, or mousepad when earbud case 1000 is being used as a computer mouse. When earbud case 1000 is in the retracted position, flat bottom 1008 may form a continuous surface along the base of earbud case 1000.

In some embodiments, flat bottom 1008 may include a section corresponding to extendable portion 1004, a section corresponding to non-extendable portion 1006, and a section corresponding to body portion 1014. In such embodiments, when extendable portion 1004 is in the retracted position, extendable portion 1004 (e.g., an outer shell or sleeve) may overlap and cover at least a part of body portion 1014, including the section of flat bottom 1008 corresponding to body portion 1014. And, when extendable portion 1004 is in the extended position, the translation of extendable portion 1004 may reduce overlap such that the section of flat bottom 1008 corresponding to body portion 1014 becomes externally visible. In such embodiments, overlap between the shell and the one or more portions of the body is reduced when extendable portion 1004 is in the extended position relative to when extendable portion 1004 is in the retracted position. The overlapping sections of earbud case 1000 may allow for the flat bottom 1008 to maintain a substantially continuous surface in the retracted and/or the extended position by minimizing or eliminating gaps between adjacent sections.

FIG. 11A depicts a perspective side view of earbud case 1000 in an extended position with slidable member 1002 in an open position. As shown, extendable portion 1004 is depicted as having moved from a retracted position to an extended position. In some implementations, body portion 1014 is a portion of the body of earbud case 1000 that is externally visible when extendable portion 1004 is in the extended position. Body portion 1014 may be an outer wall or exterior surface of earbud case 1000 that is overlapped and/or covered by extendable portion 1004 when extendable portion 1004 is in the retracted position and is uncovered and externally visible when extendable portion 1004 extends (e.g., when extendable portion 1004 is an outer shell or sleeve and moves forward and no longer overlaps body portion 1014). In some embodiments, extendable portion 1004 and body portion 1014 may overlap such that when extendable portion 1004 is in a retracted position body portion 1014 may cover a portion of extendable portion 1004 and the covered portion of extendable portion 1004 may be externally visible when extendable portion 1004 moves to an extended position. In such embodiments, overlap between the shell and the one or more portions of the body may be reduced when extendable portion 1004 moves from the retracted position to the extended position. In such embodiments, overlap between extendable portion 1004 and body portion 1014 may be reduced when extendable portion 1004 is in the extended position relative to the retracted position.

In some embodiments, all or a portion of the active electronics for the earbud case and the computer mouse are enclosed behind body portion 1014 such that when earbud case 1000 is in an extended or retracted position the internal components (e.g., electronics, circuit components, circuit boards, sensors, or similar components) of earbud case 1000 are not exposed. For example, in some embodiments a circuit board, such as circuit board 1700, is housed in body portion 1014 and remains covered by an outer surface of body portion 1014 when extendable portion 1004 is in the extended or retracted position. In some embodiments, all or a portion of the active electronics for earbud case 1000 are disposed within non-extendable portion 1006.

In some embodiments, the earbud case 1000 includes a removable host-interface accessory stored within the body (e.g., within body portion 1014, within extendable portion 1004, and/or within non-extendable portion 1006). The removable host-interface accessory may comprise a USB dongle having a USB connector and a wireless transceiver. The USB dongle may be removably retained within the earbud case 1000 by a friction fit, magnetic retention, detent feature, latch, and/or other retention mechanism, and may be removed by a user and inserted into a USB port of a host device.

In some embodiments, the USB dongle comprises a host interface component that, when inserted into the host device, causes the earbud case 1000 and/or the USB dongle to present an audio device interface to the host device, and the earbud case 1000 bridges audio between the host device and one or more earbuds over a wireless link. The USB dongle may enumerate to the host device as a HID device for mouse input and/or as a USB Audio Class device for audio communications, while the earbud case 1000 bridges mouse and/or audio data between the host device and one or more earbuds.

In some embodiments, the USB dongle is pre-associated with the earbud case 1000 (e.g., via stored encryption keys) such that, upon insertion into the host device, the USB dongle automatically establishes a wireless link with the earbud case 1000 without requiring user-driven pairing steps on the host device. In some embodiments, the earbud case 1000 maintains a wireless audio connection with the earbuds and forwards audio to/from the USB dongle over the wireless link between the earbud case 1000 and the USB dongle. In other embodiments, the USB dongle directly maintains a wireless audio connection with the earbuds and the earbud case 1000 provides association information and/or assists in establishing the wireless audio connection (e.g., by initiating pairing when earbuds are placed in the case).

In some embodiments, the earbud case 1000 maintains a wireless audio connection with the earbuds and forwards audio to/from the USB dongle over the wireless link between the earbud case 1000 and the USB dongle. In other embodiments, the USB dongle directly maintains a wireless audio connection with the earbuds and the earbud case 1000 provides association information and/or assists in establishing the wireless audio connection (e.g., by initiating pairing when earbuds are placed in the case).

Slidable member 1002 may include one or more actuating support members 1016. Each actuating support member 1016 may include a rigid or semirigid support bar coupled to slidable member 1002 and positioned beneath a corresponding compliant area of slidable member 1002. When slidable member 1002 is in an open position, actuating support member 1016 may be positioned in an actuating position in which actuating support member 1016 is aligned with, and positioned to activate, an underlying mouse button. Compression of the corresponding compliant area can cause actuating support member 1016 to travel and transmit a force to an underlying mouse button, thereby activating the mouse button. Activation of the underlying mouse button may cause generation of a click signal (e.g., a first click signal or a second click signal) that is provided to processing device 502 to generate a corresponding left click command or right click command. Actuating support member 1016 may be configured to move, slide, or translate between resting and actuating positions as slidable member 1002 transitions between a closed position and the open position. Actuating support member 1016 may be received into a track 1022 when in the resting position so slidable member 1002 can lay flush with the curved top surface. In some implementations, actuating support member 1016 includes telescoping components that extend as slidable member 1002 moves to the open position and retract as slidable member 1002 moves to the closed position. In some implementations, actuating support member 1016 includes foldable elements that collapse when slidable member 1002 is in the closed position and unfold when slidable member 1002 is in the open position such that actuating support member 1016 is positioned to transmit the click force to the underlying mouse button.

When slidable member 1002 is in an open position, slidable member 1002 may extend past the body of earbud case 1000 and may contact a support surface on which flat bottom 1008 rests. The support surface may be a mousepad, a table, a desk, or another flat surface. Contacting the support surface may provide additional stability to slidable member 1002 when the compliant areas (e.g., compliant areas 1026 and 1028) are compressed to register mouse clicks. In some embodiments, slidable member 1002 may not contact a support surface when in an open position and may be suspended above the support surface by the support members (actuating support member(s) 1016 or sensing support member(s) 1018). Extension of slidable member 1002 past the body may result in an effective length of the earbud case 1000 being greater when slidable member 1002 is in the open position than when slidable member 1002 is in the closed position. This increase in effective length may occur independently of, or in addition to, an effective length of the earbud case 1000 being greater in the extended position than in the retracted position when extendable portion 1004 moves from the retracted position to the extended position.

FIG. 11B depicts a perspective side view of earbud case 1000 in an extended position with slidable member 1002 in an open position.

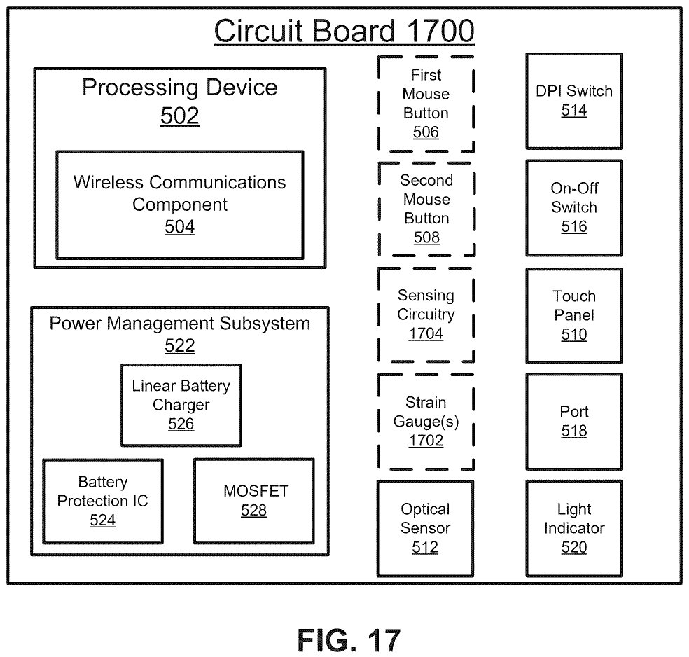

Slidable member 1002 may include one or more sensing support members 1018. Each sensing support member 1018 may comprise a rigid or semi-rigid support bar coupled to slidable member 1002 and positioned beneath a corresponding compliant area of slidable member 1002. Sensing support member 1018 may be fixed to slidable member 1002 to provide structural support to slidable member 1002. Sensing support member 1018 may be coupled to one or more sensors (such as strain gauges 1702, hall-effect sensors, force sensing resistors (FSRs), capacitive displacement sensors, an optical interrupter, or the like) which can be connected to sensing circuitry 1704 as described in FIG. 17. The following description of strain gauges 1702 is provided as an example, and it should be understood that other sensors or sensing mechanisms similar to strain gauges could also be used without departing from the spirit of the present disclosure. When slidable member 1002 is in an open position, compression of a compliant area corresponding to sensing support member 1018 may cause sensing support member 1018 to experience strain. The strain experienced by sensing support member 1018 may cause a change in voltage at strain gauge 1302 coupled to sensing support member 1018. Sensing circuitry 1704 may be configured to determine whether the voltage change exceeds a predetermined threshold. If the voltage change exceeds the predetermined threshold, the compliant area was compressed with a large enough force to register a mouse click. Sensing circuitry 1704 may generate and output a click signal (e.g., a first click signal or a second click signal) indicating a mouse click in response to the voltage change exceeding the predetermined threshold. The click signal may be transmitted to processing device 502 and used to generate a corresponding mouse command (e.g., a left click command or a right click command) for communication to a host device. In some implementations, similar sensing mechanisms that detect force, pressure, or deformation of sensing support member 1018 may be used to achieve the same or a similar functionality as the strain gauge example described above.

FIG. 12A depicts a perspective top view of earbud case 1000 in a retracted position with slidable member 1002 in an open position. As shown, earbud case 1000 includes extendable portion 1004 and non-extendable portion 1006. Lid 1012 is coupled to non-extendable portion 1006 and is configured to cover section 1024.

Section 1024 may be disposed on non-extendable portion 1006 and may receive a pair of earbuds. Section 1024 may charge the pair of earbuds when they are placed or received into section 1024. Additionally, section 1024 may include an open section that can receive different pairs of earbuds of different shapes. In some implementations, section 1024 includes an open section to receive sockets that can accommodate different shapes of earbuds. Touch panel 510 may be positioned on the curved top surface of either extendable portion 1004 or non-extendable portion 1006. Touch panel 510 may be activated by a presence of a conductive object in an area of the curved top surface above touch panel 510. Touch panel 510 may be used to complete scrolling actions for the computer mouse.

Slidable member 1002 may include a first compliant area 1026 and a second compliant area 1028. First compliant area 1026 may be disposed above a first support member and second compliant area 1028 may be disposed above a second support member. When slidable member 1002 is in an open position, compression of first compliant area 1026 may cause the generation of a first click signal, and compression of second compliant area 1028 may cause the generation of a second click signal. The first click signal and the second click signal may be provided to a processing device (such as processing device 502) and be interpreted to generate corresponding mouse commands (e.g., a left click command and a right click command) for transmission to a host device. In some embodiments, first compliant area 1026 is positioned on a left side of slidable member 1002 and second compliant area 1028 is positioned on a right side of slidable member 1002. In this example, compression of first compliant area 1026 may be registered as a left click command and compression of second compliant area 1028 may be registered as a right click command. In other examples the positioning of first compliant area 1026 and second compliant area 1028 may be reversed. First compliant area 1026 and second compliant area 1028 may take up substantially the same amount of area as each other or may take up different amounts of area. For example, first compliant area 1026 may take up a half, a third, a fourth, or other similar amount of the area that second compliant area 1028 takes up on the slidable member 1002.

A slit 1020 may be formed on slidable member 1002. Slit 1020 may be positioned between the first compliant area 1026 and the second compliant area 1028, separating the first compliant area 1026 from the second compliant area 1028. A depth of slit 1020 may be the same as a thickness of slidable member 1002, i.e., slit 1020 can cut all the way through slidable member 1002 where there is no material connecting first compliant area 1026 and second compliant area 1028 in slit 1020. In some implementations, the depth of slit 1020 may be less than the thickness of slidable member 1002, meaning there is still some material connecting first compliant area 1026 and second compliant area 1028. Slit 1020 may be used to isolate compression in one compliant area from the other compliant area to distinguish a left click from a right click.

Slidable member 1002 may include one or more tracks 1022. Tracks 1022 may accommodate the support members when slidable member 1002 is in a closed position so slidable member 1002 can lay flush with the curved top surface. Tracks 1022 may also direct the motion of slidable member 1002 when slidable member 1002 is sliding between an open position and a closed position.

FIG. 12B depicts a front view of earbud case 1000 in an extended position with slidable member 1002 in an open position. As shown, earbud case 1000 includes extendable portion 1004 and non-extendable portion 1006. Body portion 1014 is externally visible between extendable portion 1004 and non-extendable portion 1006 when earbud case 1000 is in the extended position.

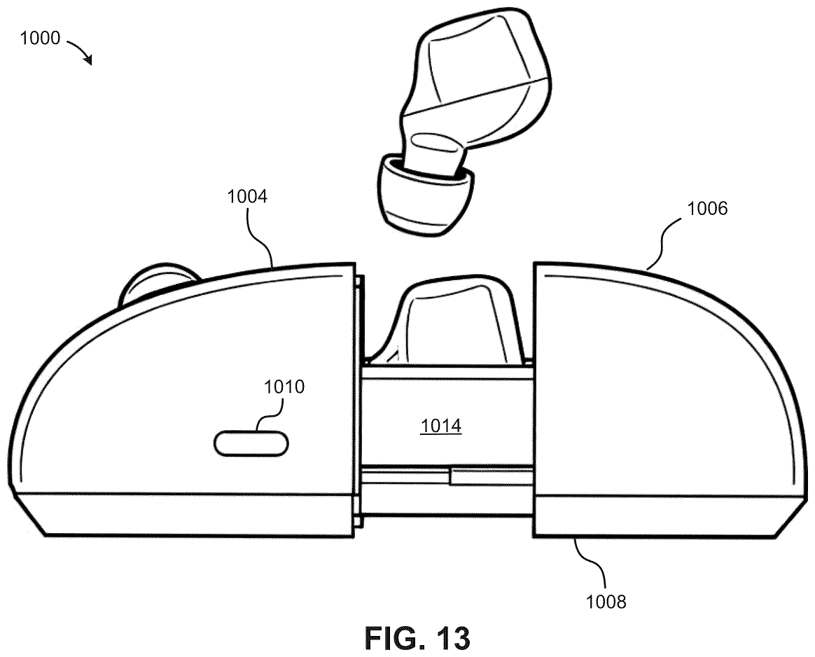

FIG. 13 depicts a perspective view of earbud case 1000 in an extended position. In some embodiments, body portion 1014 includes section 1024 for receiving the earbuds. Extending extendable portion 1004 to the extended position may result in earbud case 1000 having a greater effective length when in the extended position than in the retracted position. Extending extendable portion 1004 may expose body portion 1014 and section 1024 and allow for the retrieval and storage of the earbuds for charging.

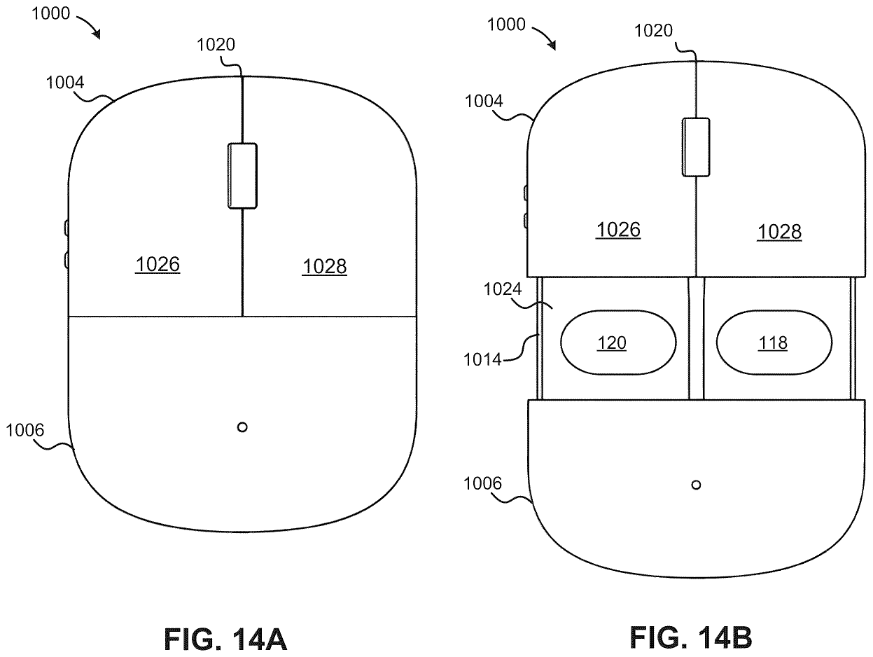

FIG. 14A depicts a top view of earbud case 1000 of FIG. 13 in a retracted position. FIG. 14B depicts a top view of earbud case 1000 of FIG. 13 in an extended position. Extending extendable portion 1004 to an extended position may include sliding extendable portion 1004 forward away from non-extendable portion 1006. Extending extendable portion 1004 to the extended position may result in earbud case 1000 having a greater effective length when in the extended position than in the retracted position. Extending extendable portion 1004 to the extended position may cause section 1024, first chamber 118, and second chamber 120 to be exposed with body portion 1014. Body portion 1014 and section 1024 may be exposed without exposing any internal components or electronics of earbud case 1000.

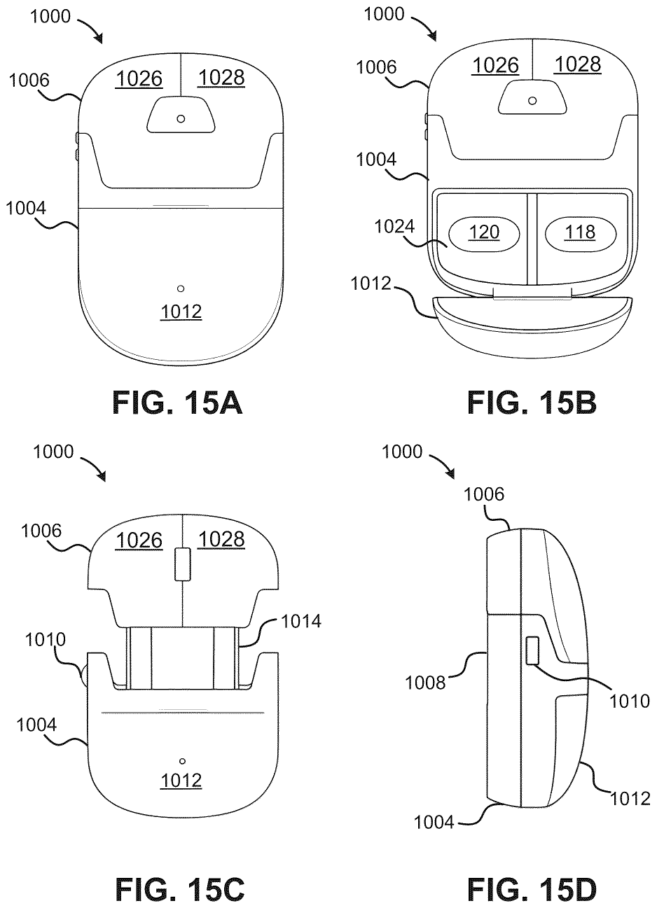

FIG. 15A depicts a top view of earbud case 1000 in a retracted position. In this embodiment, extendable portion 1004 may include section 1024 and lid 1012. FIG. 15B depicts a top view of earbud case 1000 of FIG. 15A in a retracted position with lid 1012 in an open position. FIG. 15C depicts a top view of earbud case 1000 of FIG. 15A in an extended position. Extendable portion 1004 may be located at the back of earbud case 1000 and may slide along body portion 1014 backwards away from non-extendable portion 1006. Extending extendable portion 1004 back to the extended position may result in earbud case 1000 having a greater effective length in the extended position than in the retracted position. FIG. 15D depicts a side view of earbud case 1000 of FIG. 15A in a retracted position.

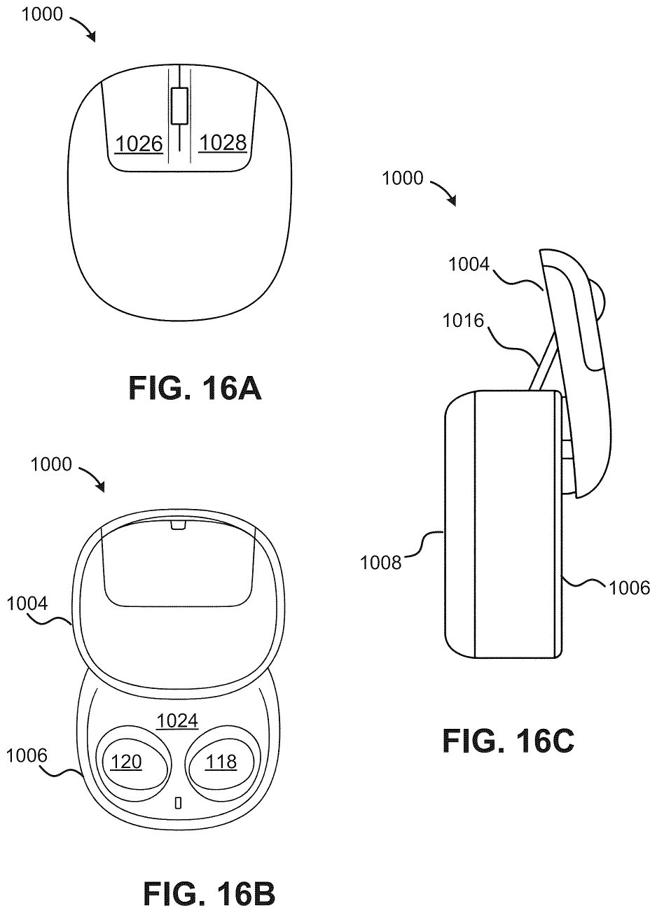

FIG. 16A depicts a top view of earbud case 1000 in a retracted position. FIG. 16B depicts a top view of earbud case 1000 of FIG. 16A in an extended position. Extending extendable portion 1004 to an extended position may include sliding extendable portion 1004 forward, thereby exposing section 1024. Extending extendable portion 1004 to the extended position may result in earbud case 1000 having a greater effective length when in the extended position than in the retracted position. Extendable portion 1004 may act as a lid to section 1024 when in the retracted position and may expose section 1024 when in the extended position. Exposing section 1024 may not expose any additional internal components of earbud case 1000. FIG. 16C depicts a top view of earbud case 1000 of FIG. 16A in an extended position with lid 1012 in an open position. In some embodiments, earbud case 1000 includes actuating support member(s) 1016 as depicted. In other embodiments, earbud case 1000 includes a sensing support member(s) 1018.

FIG. 17 depicts an example block schematic of a circuit board 1700 for use in earbud case 1000. Circuit board 1700 may include the components of circuit board 500. Circuit board 1700 may be disposed partially or completely in body portion 1014.

Circuit board 1700 may include a first mouse button 506 and a second mouse button 508. First mouse button 506 and second mouse button 508 may be used in implementations where actuating support members 1016 are configured to transmit a force to the underlying mouse buttons when slidable member 1002 is in an open position and the corresponding compliant areas are compressed. Activation of first mouse button 506 may cause generation of a first click signal, and activation of second mouse button 508 may cause generation of a second click signal, each click signal being provided to processing device 502 to generate a corresponding left click command or right click command for transmission to a host device. In such implementations, the first support member may be disposed between the first compliant area 1026 and first mouse button 506, and the second support member may be disposed between the second compliant area 1028 and second mouse button 508 when slidable member 1002 is in an open position. Slidable member 1002 being in an open position can cause the first and second support members to be in actuating positions when the support members are actuating support members. First mouse button 506 may be activated when slidable member 1002 is in an open position and the first compliant area 1026 is compressed. Second mouse button 508 may be activated when slidable member 1002 is in an open position and the second compliant area 1028 is compressed.

Circuit board 1700 may include strain gauges 1702 and sensing circuitry 1704. Strain gauges 1702 and sensing circuitry 1704 may be used in implementations where sensing support members 1018 are configured to detect compression of the corresponding compliant areas. In such implementations, a first strain gauge may be coupled to a first support member, wherein, when slidable member 1002 is in an open position, compression of first compliant area 1026 strains the first support member. Sensing circuitry 1704 coupled to the first strain gauge may be configured to output a first click signal responsive to a voltage from the first strain gauge exceeding a predetermined threshold. A second strain gauge may be coupled to a second support member, wherein, when slidable member 1002 is in an open position, compression of second compliant area 1028 strains the second support member. Sensing circuitry 1704 coupled to the second strain gauge may be configured to output a second click signal responsive to a voltage from the second strain gauge exceeding a predetermined threshold.

In some implementations, circuit board 1700 may include first mouse button 506 and second mouse button 508 without strain gauges 1702 and sensing circuitry 1704. In other implementations, circuit board 1700 may include strain gauges 1702 and sensing circuitry 1704 without first mouse button 506 and second mouse button 508. In some embodiments, circuit board 1700 may include both first mouse button 506 and second mouse button 508 as well as strain gauges 1702 and sensing circuitry 1704.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure. Furthermore, the components of the earbud case embodiments are example components, and other components or configurations may be used.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “providing”, “sending”, “adjusting”, “determining”, “playing”, or the like, may refer to the actions and processes of a microprocessor, a computing device, or a similar electronic device, that manipulates and transforms data represented as physical (e.g., electronic) quantities within the computer system's registers and memories into other data similarly represented as physical quantities within the computer system memories or registers or other such information storage, transmission or display devices.

Reference throughout this specification to “one implementation,” “an implementation,” “some implementations,” “one embodiment,” “an embodiment,” or “some embodiments” means that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term is used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion. Use of the term “a” or “an” include “one or more” unless otherwise specified.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like may refer to a computer-related entity, either hardware (e.g., a circuit), firmware, software, a combination of hardware and software, or an entity related to an operational machine with one or more specific functionalities. For example, a component can be, but is not limited to being, a process running on a processing device, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to the interaction among several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. An earbud case comprising:
a body comprising a curved top surface having ergonomics of a computer mouse and a flat bottom, wherein the body comprises:
an extendable portion configured to extend from a retracted position to an extended position, and wherein an effective length of the earbud case is greater in the extended position than in the retracted position; and
a section configured to receive a pair of earbuds, wherein the section is configured to charge the pair of earbuds when placed in the section; and
wherein the curved top surface comprises:
a compliant area, wherein compression of the compliant area causes a click signal to be generated, the click signal corresponding to a mouse command.

2. The earbud case of claim 1, wherein the curved top surface comprises:
a slidable member, slidably coupled to the curved top surface and configured to slide from a closed position to an open position, wherein the slidable member includes the compliant area, and wherein the compliant area is disposed above a support member.

3. The earbud case of claim 2, wherein the support member is disposed between the compliant area and a mouse button and is configured to activate the mouse button when the slidable member is in the open position and the compliant area is compressed to generate the click signal.

4. The earbud case of claim 2, wherein the support member is coupled to a strain gauge, and wherein when the slidable member is in the open position, compression of the compliant area strains the support member, and wherein sensing circuitry coupled to the strain gauge is configured to generate the click signal responsive to a voltage from the strain gauge exceeding a predetermined threshold.

5. The earbud case of claim 2, wherein the slidable member is configured to extend past the body and to contact a support surface on which the flat bottom rests when the slidable member is in the open position.

6. The earbud case of claim 1, wherein the extendable portion is releasably retained in the retracted position with a detent mechanism.

7. The earbud case of claim 1, wherein the extendable portion comprises a shell that overlaps with one or more portions of the body when in the retracted position and wherein overlap between the shell and the one or more portions of the body is reduced when the extendable portion is in the extended position relative to the retracted position.

8. The earbud case of claim 1, wherein the earbud case is configured to operate in a PC mode and a Bluetooth mode, wherein in the PC mode the earbud case couples to a host device through a wired interface or a wireless receiver, and wherein in the Bluetooth mode the earbud case wirelessly connects to one or more devices using Bluetooth, and wherein the earbud case comprises switching logic to transition between the PC mode and the Bluetooth mode.

9. The earbud case of claim 1, further comprising a host interface component to communicatively couple the earbud case to a host device, wherein the earbud case presents an audio device interface to the host device and bridges audio between the host device and at least one earbud over a wireless link, and wherein the earbud case is to automatically enumerate as a human-interface-device (HID) for mouse input upon connecting to the host device.

10. An earbud system comprising:
an earbud case;
a first earbud; and
a second earbud, wherein the earbud case comprises:
a battery;
a circuit board having electronics comprising:
a power management sub-system coupled to the battery;
a processing device; and
a wireless communications component; and
a body comprising a curved top surface having ergonomics of a computer mouse and a flat bottom, wherein the body comprises:
an extendable portion configured to extend from a retracted position to an extended position, and wherein an effective length of the earbud case is greater in the extended position than in the retracted position; and,
a section configured to receive the first and second earbuds, wherein the section is configured to charge the first and second earbuds when placed in the section; and
wherein the curved top surface comprises:
a compliant area, wherein compression of the compliant area causes a click signal to be generated, the click signal corresponding to a mouse command.

11. The earbud system of claim 10, wherein the curved top surface comprises:
a slidable member, slidably coupled to the curved top surface and configured to slide from a closed position to an open position, wherein the slidable member includes the compliant area, and wherein the compliant area is disposed above a support member.

12. The earbud system of claim 11, wherein the slidable member is configured to extend past the body and to contact a support surface on which the flat bottom rests when the slidable member is in the open position.

13. The earbud system of claim 11, wherein the support member is disposed between the compliant area and a mouse button and is configured to activate the mouse button when the slidable member is in the open position and the compliant area is compressed to generate the click signal.

14. The earbud system of claim 11, wherein the support member is coupled to a strain gauge, and wherein when the slidable member is in the open position, compression of the compliant area strains the support member, and wherein sensing circuitry coupled to the strain gauge is configured to generate the click signal responsive to a voltage from the strain gauge exceeding a predetermined threshold.

15. The earbud system of claim 10, wherein the extendable portion is releasably retained in the retracted position with a detent mechanism.

16. The earbud system of claim 10, wherein the extendable portion comprises a shell that overlaps with one or more portions of the body when in the retracted position and wherein overlap between the shell and the one or more portions of the body is reduced when the extendable portion is in the extended position relative to the retracted position.

17. The earbud system of claim 10, wherein the earbud case is configured to operate in a PC mode and a Bluetooth mode, wherein in the PC mode the earbud case couples to a host device through a wired interface or a wireless receiver, and wherein in the Bluetooth mode the earbud case wirelessly connects to one or more devices using Bluetooth, and wherein the earbud case comprises switching logic to transition between the PC mode and the Bluetooth mode.

18. The earbud system of claim 10, wherein the processing device is programmed to:
communicatively couple the earbud case to a host device by the wireless communications component;
transmit wireless communications from the earbud case to the host device by the wireless communications component; and
receive wireless communications from the host device by the wireless communications component.

19. The earbud system of claim 10, further comprising a host interface component to communicatively couple the earbud case to a host device, wherein the earbud case presents an audio device interface to the host device and bridges audio between the host device and at least one earbud over a wireless link, and wherein the processing device is programmed to automatically enumerate the earbud case as a human-interface-device (HID) for mouse input upon connecting to the host device.

20. An earbud case comprising:
a battery;
a circuit board comprising electronics comprising:
a power management sub-system coupled to the battery;
a processing device; and
a wireless communications component;
a mouse button;
a body comprising a curved top surface having ergonomics of a computer mouse and a flat bottom, wherein the body comprises:
an extendable portion configured to extend from a retracted position to an extended position, wherein an effective length of the earbud case is greater in the extended position than in the retracted position; and
wherein the curved top surface comprises:
a slidable member, slidably coupled to the curved top surface, having a compliant area and a support member, wherein:
the compliant area is disposed above the support member, and wherein the support member is disposed between the compliant area and the mouse button and is configured to activate the mouse button when the slidable member is in an open position and the compliant area is compressed; and
a touch panel, wherein the touch panel is activated by a presence of a conductive object in an area of the curved top surface above the touch panel; and
a section configured to receive a pair of earbuds, wherein the section is configured to charge the pair of earbuds when placed in the section.
